(19) United States
(12) Patent Application Publication
(10) Pub. No.: US 2004/0027494 A1
(43) Pub. Date: Feb. 12, 2004

(54) Monitoring system

(76) Inventor: Neale Thomas, Birmingham (GB)

Correspondence Address: YOUNG & THOMPSON, 745 SOUTH 23RD STREET 2ND FLOOR, ARLINGTON, VA, 22202

(21) Appl. No.: 10/362,604

(22) PCT Filed: Aug. 24, 2001
(86) PCT No.: PCT/GB01/03815

(51) Int. Cl. H04N 5/14

(52) U.S. Cl. 348/700; 348/152

(57) ABSTRACT

A camera is set up to survey an area of water, recording images of the whole area, or scanning it section by section. Each image is compared with a previous one of the same area, captured under the same ambient conditions in the past and selected from a library holding images of the area under many different ambient condition, all without pollution or contaminants affecting the surface signature. Alternatively, the comparison is made with a recent image, taken as part of a sequence. Image analysis software can determine if there are differences between the images indicative of pollution, such as by an oil slick, ad an alarm can then be raised to prompt more detailed investigation. The system can have applications to other environments where changes may be determined or at least need to be monitored.

This invention relates to a monitoring system. It is being developed particularly for monitoring areas of sea for waterborne pollutants, such as oil slicks or sewage trails and will be discussed below primarily in those terms. But it could have other applications, some of which will be mentioned later.

Currently, the usual method of testing for pollution of water is to take spot samples, transfer them to a laboratory and analyse them there. This has many disadvantages. For example, there is the expense of conveyance between sample site and laboratory and the time lag involved. A typical assay may take two weeks, by which time severe damage may have been done. Such tests are necessarily occasional and localised, and therefore give an unreliable picture of contamination over a large area. Also, they give no information as to how long a pollutant has been in the water, where it is coming from and likely to be travelling to, and what area is covered.

It is the object of this invention to provide a monitoring system with a much more rapid reaction time and which can make a provisional assessment of a large area very cheaply.

According to the present invention there is provided a monitoring system comprising a camera with a scan program for recording images of an area over a period of time, means for comparing the images, and means for signalling when significant differences between images occur.

The scan program may direct the camera successively at different sections of the area to build up a composite image thereof. Also the camera may have an associated monitor and controls by which a supervisor can over-ride the scan program and view a selected section of the area in enlarged detail. The signalling means are preferably suppressed until a significant difference has been consistently present for a predetermined number of images. In other words, features that occur within the area on a discontinuous basis are disregarded. This guards against transient anomalies giving rise to an alarm signal, when what is wanted is an indication of relatively steady, long-term changes.

In one form the images of the area may be recorded under various different ambient conditions. The comparing means then uses the image previously taken under ambient conditions closest to the current conditions when making a comparison with a current image. But, as explained later, this is likely to pose problems in some applications.

Therefore it may be preferred that the comparing means uses at least one image of an immediately preceding sequence of images when making a comparison with a current image. In other words a large library of images does not have to be stored; it is assumed that ambient conditions will not change very much over a short period when several images are recorded, and so the latest image in a sequence is compared with at least one earlier one.

Advantageously, there are means for determining from successive images the speed of a feature traversing the area that creates a significant difference between those images and previous ones without that feature. A feature whose speed is determined as exceeding a predetermined value can be disregarded.

There may also be means for determining from successive images the direction of motion of a feature traversing the area that creates a significant difference between those images and previous ones without that feature. A feature whose motion is determined to be in a certain direction can be disregarded.

The invention will now be discussed in more detail using monitoring an area of water as a prime example.

It is well known that an oil slick, for example, or an algal bloom, or a plume from a sewage outfall, will materially affect the surface appearance of the water over which it extends.

The appearance or “surface signature” of non-polluted water can be observed and recorded for various times of day, sunlit or cloudy, and with different wind strengths and directions, to build up a library of pictures. Then, when the observed picture does not accord with what could be expected from ambient conditions, there can be a strong presumption that something in the water is affecting its surface behaviour or appearance.

This library will have to be extensive. For example, sunlight will cause the water to glint, but factors such as the position of the sun, the sea state and the wind direction (which largely determines the orientation of the waves) all combine to give a particular glint signature. Without direct sunlight, for example on an overcast day, the position of the sun becomes almost irrelevant since its light is diffused and there is no glinting. So then the signature of the sea surface is a combination of shades of grey.

Such a library may take a long time, years perhaps, to build up into a really comprehensive one. The processor choosing the image also requires a lot of information to be input, such as time of day and season, state of tide, wind strength and direction, general sea state, cloud cover and so on. While some of these parameters are straightforward, others can be variable from moment to moment and are therefore more problematic. It may be necessary to average them over a period.

Therefore another, preferred approach is for the scanned waterscape to be analysed for the appearance of differences between areas or of discontinuities, on the premise that in normal conditions there will be substantial regularity or uniformity over the whole picture. Images would be recorded at regular intervals so that not only would the existence of an anomaly be noted but also its development or movement. Just one pair of scans would not safely provide sufficient evidence: the confirmation afforded by several scans suggesting that the anomaly was behaving like a released pollutant would normally be obtained before an alarm was raised.

However, it must also be recognised that there are some surface anomalies which are harmless or even benign. For example, there may be headlands or shallows that create regular and predictable disturbances to that uniformity, but they can be factored out. There are less predictable ones such as the wakes of vessels, which can linger as distinct paths across the surface for a considerable time. But they generally have a speed of development (equal to the speed of the vessel) far greater than the drift of a patch of pollutants and successive scans would enable them to be discounted. The direction of motion can also be used to discount certain features. For example, if the tidal stream or current is known and input, something moving against it is going to be a vessel and not an oil slick. Cloud shadows could also be problematic, although generally there will be a breeze moving them at a much greater rate than any current taking with it a patch of oil, say. Likewise “catspaws” of wind on an otherwise calm surface might give a false alarm, but usually they are transient and quick moving and can be ignored for those characteristics.

On the other hand, there are certain harmless surface signatures which are less easy to distinguish, such as patches of seaweed or fish shoals. However, a visual check by the operator in charge (either directly through binoculars, for example, if he is stationed near the camera, or by viewing the camera output on a screen) may be sufficient to quiet suspicion.

Such analysis will not usually reveal what the contaminant or pollutant is, although experiments have shown that it may be possible to identify the signatures and morphologies of certain pollutants. So while spot sampling will still be a necessary requirement, the system should eliminate the need to use it for the basic detection. That step is achieved by the system giving early warning of significant departures of the appearance of at least some of the surface from the expected norm. If that is the case, spot sampling can then complete this identification.

It is envisaged that a camera mounted at the top of a pole similar to modern lamp posts would be able to monitor approximately 1 km² of water. The camera used is a matter of choice and budget. A standard surveillance camera may be quite adequate for some purposes, but more sophisticated ones could be employed. If its output is not digital, then there are known techniques for digesting an image, and it is most convenient to have the visual information in that form for comparison purposes. An infra red (IR) camera may be used to obtain enhanced imaging of thermal patterns—pollution will often be at a different temperature (usually higher) than the surrounding sea. It may also be useful to have a camera that extends its range into the ultra-violet (UV) part of the electromagnetic spectrum, or indeed beyond. A polarising filter could produce better results in some circumstances. There may be a fixed field of view, or a camera with zoom and/or facility to tilt and pan, as mentioned above. The system as currently conceived will usually be shore based, or on a solid structure such as an oil rig or lighthouse, and typically such a camera would be arranged to look out beyond the low tide mark to an inshore patch of water. However, it may be practical to have it ship-borne or buoyed at any chosen offshore point or even carried by a balloon tethered to shore, ship or buoy. At such a remote location without power, a solar-powered camera would be appropriate, with solar-powered transmission.

The camera may be a “smart” camera, equipped with the means for analysing what it sees in the manner described above and just having as its output an alarm to signify that there is an excursion from the normal which needs further investigation.

Otherwise the communication between camera and a control station where the comparison and analysis takes place may be by any convenient means of transmission. If the two are adjacent then of course they may be connected by cable, but for more distant transmission telephone or the internet will probably be the best low cost answer, particularly as only one frame (typically <200 KB) may be sent every ten to fifteen minutes.

The comparison of two digitised images be carried out using commercially available image analysis software in a P.C., although more sophisticated software is being developed and more computing power may be necessary.

Trials indicate that converting the image into small areas each with a Grey scale number between 1 and 256, and determining if there are adjacent zones where the difference in Grey. scale numbers across the boundary is 20 or more, can be indicative of a patch of pollution when that boundary did not previously exist.

The frequency of inspection by the camera is a matter of choice, but it is anticipated that it should suffice for each section of target water surface to be evaluated at that rate. But in calm conditions, the frequency might be lowered as change will be slow.

This surveillance can be of open sea, lochs, estuaries, rivers, lakes, reservoirs, or indeed any stretch of water. But as mentioned at the outset, it could be applied to other areas. For example, a beach or shoreline could be monitored for erosion or migration of sand or shingle, or for the deposition of rubbish. It could have traffic applications, such as giving an alarm when traffic has been observed by camera to have to come to a standstill. There are security possibilities, such as signalling that something is in the field of view that was not there previously.

1. A monitoring system comprising a camera with a scan program for recording images of an area over a period of time, means for comparing the images, and means for signalling when significant differences between images occur.

2. A monitoring system as claimed in claim 1, wherein the scan program directs the camera successively at different sections of the area to build up a composite image thereof.

3. A monitoring system as claimed in claim 1 or 2, wherein the camera has an associated monitor and controls by which a supervisor can over-ride the scan program and view a selected section of the area in enlarged detail.

4. A monitoring system as claimed in claims 1, 2 or 3, wherein the signalling means are suppressed until a significant difference has been consistently present for a predetermined number of images.

5. A monitoring system as claimed in any preceding claim, wherein the images of the area are recorded under various different ambient conditions and the comparing means uses the image previously taken under ambient conditions closest to the current conditions when making a comparison with a current image.

6. A monitoring system as claimed in any of claims 1 to 4, wherein the comparing means uses at least one image of an immediately preceding sequence of images when making a comparison with a current image.

7. A monitoring system as claimed in any preceding claim, wherein there are means for determining from successive images the speed of a feature traversing the area that creates a significant difference between those images and previous ones without that feature.

8. A monitoring system as claimed in claim 7, wherein there are means for disregarding a feature whose speed is determined as exceeding a predetermined value.

9. A monitoring system as claimed in any preceding claims, wherein there are means for determining from successive images the direction of motion of a feature traversing the area that creates a significant difference between those images and previous ones without that feature.

10. A monitoring system as claimed in claim 9, wherein there are means for disregarding a feature whose motion is determined to be in a certain direction.

11. A monitoring system as claimed in any preceding claims, wherein the area is an area of water.
